(19) United States
(12) Patent Application Publication
(10) Pub. No.: US 2013/0285780 A1
(43) Pub. Date: Oct. 31, 2013

(54) MAGNETIC DRIVE

(71) Applicant: Richard Nagy, Wien (AT)

(72) Inventor: Richard Nagy, Wien (AT)

(21) Appl. No.: 13/883,068

(22) PCT Filed: Nov. 2, 2011
(86) PCT No.: PCT/AT2011/000445

§ 371 Date: Jul. 12, 2013

(30) Foreign Application Priority Data
Nov. 3, 2010 (AT) A 1811/2010

(51) Int. Cl. H01F 7/02

(52) U.S. Cl. CPC H01F 7/02
USPC 335/306

(57) ABSTRACT

A magnetic drive including a first magnet and a second magnet, wherein the first magnet is positioned in a way that it is constantly within the sphere of influence of the second magnet, wherein the second magnet includes several second individual magnets, which are all spaced apart by gaps, wherein local field strength peaks controllable with regard to the position of the first magnet relative to the second magnet can be generated in the second magnet by means of a magnetization means so that the first magnet is movable relative to the second magnet by means of the attractive force between different poles of the first magnet and of the second magnet controlled by the controllable local field strength peaks, or by means of the repulsive force of equal poles of the first magnet and the second magnet controlled by the controllable local field strength peaks.

### CROSS-REFERENCE TO RELATED APPLICATIONS

This application is a Section 371 of International Application No. PCT/AT2011/000445, filed Nov. 2, 2011, which was published in the German language on May 10, 2012, under International Publication No. WP 2012/058704 A8 and the disclosure of which is incorporated herein by reference.

### BACKGROUND OF THE INVENTION

The present invention relates to a magnetic drive comprising a first magnet and a second magnet, wherein the first magnet is positioned in a way that it is constantly within the sphere of influence of the second magnet.

### BRIEF SUMMARY OF THE INVENTION

The object of the invention discussed herein is to provide a magnetic drive wherein a first magnet is moved relative to a second magnet according to the principle of local superposition of field strengths. According to the invention, this is achieved by the second magnet comprising several second individual magnets, which are each spaced apart from each other by one gap, wherein local field strength peaks controllable with regard to the position of the first magnet relative to the second magnet can be generated in the second magnet by means of a magnetization means so that the first magnet is movable relative to the second magnet by means of the attractive force between different poles of the first magnet and of the second magnet controlled by the controllable local field strength peaks, or by means of the repulsive force of equal poles of the first magnet and the second magnet controlled by the controllable local field strength peaks.

The generation of field strength peaks in the magnetic field of the second magnet leads to an orientation of the attractive or repulsive forces in the movement direction of the first magnet. The first magnet is moved to such a field strength peak by means of attractive forces or moved away from such a field strength peak by means of repulsive forces.

The present invention may be characterized by the fact that the side of the first magnet that faces the second magnet has a shorter or the same length compared to the side of the second magnet that faces the first magnet.

In one embodiment, the first magnet and the second magnet are permanent magnets. The first magnet and the second magnet may also be provided in the form of electric magnets.

A variation of the inventive magnetic drive is characterized by the fact that a third permanent magnet is provided as a magnetization means in the region of the gap and is displaceable between a position within the gap and a position outside the gap, wherein the third permanent magnet is, in the position within the gap, oriented towards the adjacent second individual magnets with the same pole, and field strength peaks may be generated in the region of the gap by positioning the third permanent magnet within or in the region of the respective gap.

In this variation of an inventive magnetic drive, the field strength peak is found in the region of the respective gap within which the third permanent magnet is positioned. The above arrangement of the poles of the third permanent magnet with regard to the second individual magnets of the second magnets results in an increase of the field strength of both poles through the third permanent magnet.

The position of the third permanent magnet with regard to the second individual magnet allows controlling the field strength peak. It is not excluded by the present invention that the third permanent magnet may be positioned within a gap in a way that the field strength peak of one pole is increased stronger than that of another pole.

In one embodiment of the magnetic drive discussed herein, the third permanent magnet can be positionable by displacement of the second magnet in the gap. This displacement may be parallel or at any angle to the repulsive forces present between the second magnet and the third permanent magnet. Displacement of the third permanent magnet at a preferably right angle to the repulsive forces present between the second magnet and the third permanent magnet can have the advantage that the portion of the repulsive force that acts against the displacement direction of the third permanent magnet is small.

In one possible embodiment, displacement of the third permanent magnet is coupled with the movement of the first magnet relative to the second magnet.

Positioning the third permanent magnet within the gap leads to the partitioning of the second magnet into individual magnets. If no third permanent magnet is arranged in the gap, the second magnet acts as one magnet.

The inventive magnetic drive may also be formed such that a device for generating an electromagnetic field is arranged as magnetization means adjacent to the second magnet, wherein the electromagnetic field is oriented towards the second magnet with the same poles and an electromagnetic strength peak can be generated. The device for generating an electromagnetic field may be positioned in the region of the gap, wherein the device is oriented towards the adjacent second individual magnets with the same poles and a field strength peak may be generated in the region of the gap.

Within the framework of the present invention, the device for generating an electromagnetic field may be combined with the third permanent magnet.

The inventive magnetic drive can comprise a device so that the first magnet is arranged at a predefined distance from the second magnet.

Usually, the magnetic drive comprises a device for guiding the first magnet with regard to the second magnet so that the first magnet is spaced from the second magnet at a predefined distance.

One embodiment of the inventive magnetic drive relates to a rotary drive characterized in that the second magnet is arranged around the first magnet, the polar axis of the second magnet is parallel with the arrangement of the second magnet, and the first magnet is mounted rotatably around the center of the arrangement of the second magnet, so that a rotating movement of the first magnet relative to the second magnet can be generated.

The first magnet can, for example, be provided as a rod, the center of which is pivotally mounted and the free ends of which each have a pole.

The second magnet can, for example, have the shape of a ring, a toroid or a ball arranged around the support point of the first magnet.

This embodiment usually comprises an axis for the transmission of the rotary motion from the rotating first magnet to an element to be rotated.

A further embodiment of the inventive magnetic drive relates to a linear drive characterized in that the second magnet extends along a polygonal line, the polar axis of the second magnet is oriented parallel with the polygonal line, and the first magnet is movable parallel with the polar axis.

The inventive drive can, for example, be used as a linear drive, wherein the second magnet extends along a polygonal line, the polar axis of the second magnets runs parallel with the polygonal axis, and the first magnet is moved along the second magnet.

The invention discussed herein does not exclude that the first magnet and/or the second magnet and/or optionally the third permanent magnet may be powered by an external energy source.

The velocity of the movement of the first magnet and/or the power of the magnetic drive are controllable via the strength of the field strength peaks and/or the distance between the first magnet and the second magnet.

The principle of moving the first magnet relative to the second magnet comprising several second individual magnets is based on the fact that the field strength peaks are, seen in the movement direction of the first magnet, arranged before the first magnet when the first magnet is moved by the attractive forces between the first magnet and the second magnet, or arranged, seen in the movement direction of the first magnet, after the first magnet when the first magnet is moved by the repulsive forces between the first magnet and the second magnet. If the first magnet is in the region of the, seen in the movement direction, first polar field, towards which the first magnet is oriented with the same poles, the field strength peak for driving the first magnet is arranged in the region of the, seen in the movement direction, first gap. The drive for the first magnet in the region of the, seen in the movement direction, second polar field, towards which the first magnet is oriented with different poles, is caused by a field strength peak arranged in the, seen in the movement direction, second gap.

When the first magnet is moved in the region of a gap, there is preferably no field peak in the region of the respective gap.

One embodiment of the inventive magnetic drive may be characterized by the fact that the magnetic drive comprises several first magnets, wherein the first magnet and a further first magnet are coupled with each other, and the first magnet is positioned in the region of a second individual magnet, preferably in the region of the first polar field, while the further first magnet is positioned in the region of a gap.

By coupling the first magnet with a further first magnet, the first magnet can be moved by the further first magnet across a magnet-free region or across a region with a constant magnetic field.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

Fig. shows a schematic representation of an inventive magnetic drive with two magnets at a time t.

FIG. 2 shows the inventive magnetic drive shown in FIG. 1 with two magnets at a time t+1.

FIG. 3 shows a schematic representation of an inventive magnetic rotary drive with four magnets.

FIG. 4 shows a schematic representation of an inventive magnetic linear drive at a time t.

FIG. 5 shows the magnetic linear drive shown in FIG. 3 at a time t+1.

FIG. 6 shows a magnetic rotary drive similar to the magnetic rotary drive shown in FIG. 2 at a time t.

FIG. 7 shows the magnetic rotary drive shown in FIG. 5 at a time t+1.

### DETAILED DESCRIPTION OF THE INVENTION

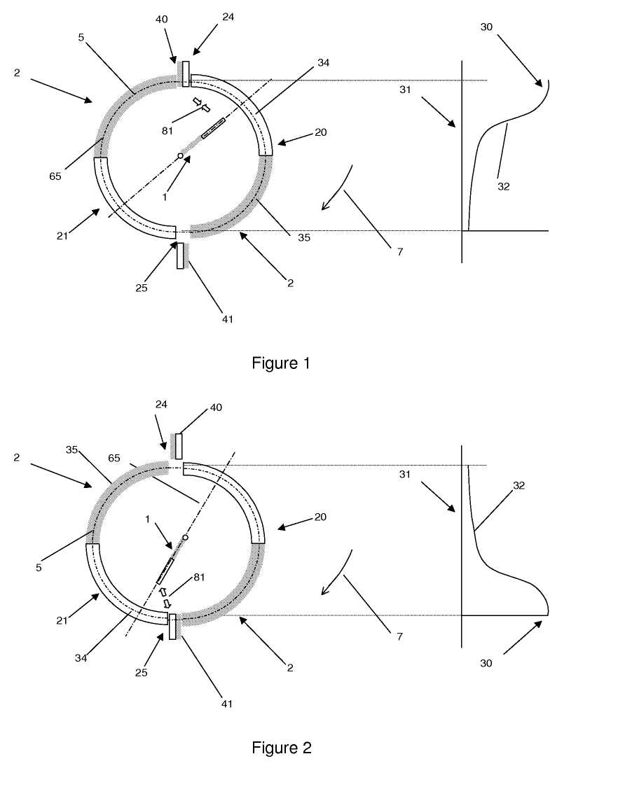

FIG. 1 and FIG. 2 show a schematic representation of an inventive magnetic rotary drive, wherein FIG. 1 relates to a time t, and FIG. 2 relates to a later time t+1. The magnetic drive comprises a first magnet 1 and a second magnet 2 that are arranged with regard to each other, wherein the first magnet 1 is positioned in a way with regard to the second magnet 2 that a distance between the first magnet 1 and the second magnet 2 is prevented. Due to this positioning, the first magnet 1 is constantly within the sphere of influence of the second magnet 2.

The second magnet 2 comprises several second individual magnets 20, 21, which are all spaced apart by gaps 24, 25. The first magnet 1 has an elongate shape and has different poles at its ends. One polar field of the first magnet has a greater distance to the second magnet than the other polar field of the first magnet.

The second magnet 2 is arranged around the first magnet 1 in a substantially circular form. The polar axis 5 of the second magnet 2 has the shape of a circle. The first magnet 1 is mounted rotatably around the center of the circular arrangement of the second magnet 2 so that a rotating movement of the first magnet 1 relative to the second magnet 2 can be generated. Due to this arrangement, the first magnet 1 has a predefined distance from the second magnet 2.

The second magnet 2 has local field strength peaks 30 so that the first magnet 1 is moved relative to the second magnet 2 by means of the repulsive force 81 between equal poles of the first magnet 1 and the second magnet 2.

The field strength peak 30 is generated based on the principle of summing up the field strengths by arranging a third permanent magnet 40, 41 in the gap formed by the two individual magnets 20, 21. The third permanent magnet 40, 41 is oriented towards the second individual magnet 20, 21 of the second magnet 2 with the same pole. For generating the field strength peaks 30 in the embodiment shown in FIG. 1 and FIG. 2, third permanent magnets 40, 41 are arranged as magnetizing means in the region of the gap 24, 25. The third permanent magnets 40, 41 are displaceable between a position within the gap 24, 25 for generating a field strength 30 and a position outside the gap 24, 25. When the third permanent magnets 40, 41 are positioned outside the gap 24, 25, no field strength peak 30 is generated in the region of the gap 24, 25.

The third permanent magnets 40, 41 are, in the position within the gaps 24, 25, oriented towards the adjacent second individual magnets 20, 21 with the same poles so that a field strength peak 30 in the region of the gaps 24, 25 can be generated by displacing the respective third permanent magnet 40, 41 into the or into a position adjacent to the respective gap 24, 25.

Graph 31 shows a schematic course 32 of the field strength in the region of the second individual magnets 20, 21 with the field strength peak 30.

The inventive drive is designed in a way that the first magnet 1 and/or the second magnet 2 are permanent magnets. By means of the strength of the field strength peaks 30, the velocity of the movement of the first magnet 1 and/or the power of the magnetic drive can be controlled.

The movement of the first magnet 1 relative to the second magnet is always based on the principle that the field strength peak 30 is, seen in the movement direction 7 of the first magnet 1, arranged before the first magnet 1 (not shown) when the first magnet 1 is moved by the attractive forces between the first magnet 1 and the second magnet 2, or arranged after the first magnet 1 (see FIG. 1 and FIG. 2) when the first magnet 1 is moved by the repulsive forces 81 between the first magnet 1 and the second magnet 2.

The repulsive forces 81 and the attractive forces have a local maximum in the region of the field strength peaks 30.

In the exemplary embodiment shown in FIG. 1, this is achieved by arranging the field strength peak 30 for driving the first magnet 1 in the region of the, seen in the movement direction, first polar field 34, towards which the first magnet 1 is oriented with the same poles, and in the region of the gap 24.

For moving the first magnet 1 across the gap 24, 25, there is no field peak 30 in the respective gap.

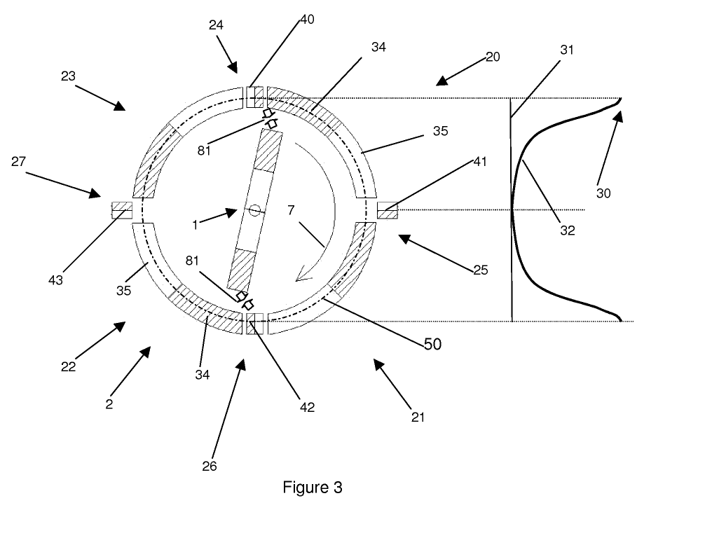

FIG. 3 shows a schematic representation of an inventive magnetic drive, wherein the second magnet 2 has four individual magnets 20, 21, 22, 23. The design and the operating mode of the magnetic rotary drive shown in FIG. 1 are similar to the magnetic rotary drive shown in FIG. 1, with the exception that the first magnet 1 has equal poles at its ends. The ends of the first magnet 1 have a defined distance to the second magnet 2.

FIG. 3 shows a schematic representation of an inventive magnetic linear drive at a time t, wherein the first magnet 1 is guided by the second magnet 2 at a predefined distance parallel with the extension of the second magnet 2. The first magnet 1 and the further first magnet 1′ are coupled with each other.

At the time t, the field strength peaks 30 are arranged in the region of the gaps 24, 26. By arranging the third permanent magnets 40, 42 in the gaps 24, 26, field strength peaks 30 are generated in the region of the gaps 24, 26. The first magnet is moved by the repulsive forces 80 between the first magnet 1 and the second magnet 2. Due to the generation of field strength peaks 30 in the region of the gap 24, 25, the repulsive forces 80 have a local maximum in this region.

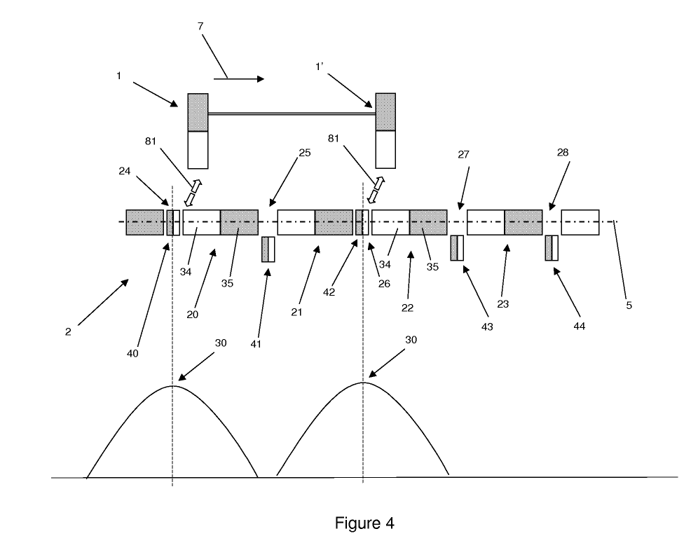

FIG. 4 shows a schematic representation of an inventive magnetic linear drive at a time t.

At the time t, the field peaks 30 are arranged in the region of the gaps 24, 26.

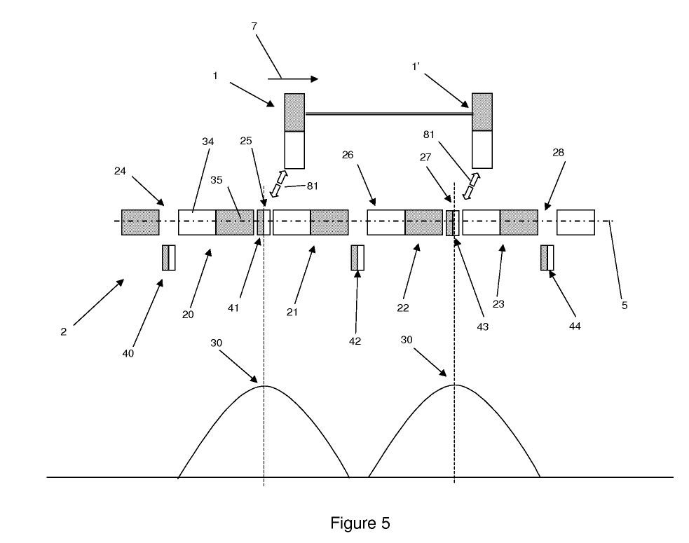

FIG. 5 shows a schematic representation of an inventive magnetic linear drive at a time t+1. At the time t+1, the field peaks 30 are arranged in the region of the gaps 25, 27. By arranging the third permanent magnets 41, 43, the field peaks 30 are generated.

In the embodiments shown in FIG. 4 and FIG. 5, the first magnet 1 comprises a first magnet 1 and a further first magnet 1′ that are rigidly joined to each other.

The polar axis 5 of the second magnet 2 extends parallel with the movement direction 7 of the first magnet 1 and the further first magnet 1′ that is to be achieved.

For moving the first magnet 1 at the time t (see FIG. 4) in the region of the first polar field 34 of the individual magnet 20, the field strength peak 30 is arranged in the region of the gap 24. For moving the further first magnet 1′ at the time t (see FIG. 5), a further field peak 30 is arranged in the region of the gap 26. For generating the field peaks 30 at the time t (see FIG. 4), a third permanent magnet 40, 42 is arranged in the respective gap 24, 26. The other third permanent magnets 41, 43, 44 are arranged outside the respective gaps 25, 27, 28 so that there are no field peaks 30 in the region of the gaps 25, 27, 28.

The movement of the first magnet 1 at the time t (see FIG. 4) is substantially caused by a repulsive force 81 generated between the first magnet 1 and the first polar field 34 of the individual magnet 20. In addition, there is an attractive force 80 between the first magnet 1 and the second polar field 35 of the individual magnet 20. The movement of the further first magnet l′ is achieved in analogy to the movement of the first magnet 1.

For moving the first magnet 1 at the time t+1 (see FIG. 5) in the region of the first polar field 34 of the individual magnet 21, the field strength peak 30 has to be arranged in the gap 25. For moving the further first magnet 1′ at the time t+1 (see FIG. 5), a further field peak 30 is arranged in the region of the gap 27. For generating the field peak 30 at the time t+1 (see FIG. 5), a third permanent magnet 41, 43 is arranged in the respective gap 25, 27. The other third permanent magnets 10, 42, 44 are arranged outside the respective gaps 24, 26, 28 so that there is no field peaks 30 in the region of the gaps 25, 27, 28.

The movement of the first magnet 1 at the time t+1 (see FIG. 5) is substantially achieved by a repulsive force 81 generated between the first magnet 1 and the first polar field 34 of the individual magnet 1. In addition, there is an attractive force 80 between the first magnet 1 and the second polar field 35 of the individual magnet 21. The movement of the further first magnet 1′ is achieved in analogy to the movement of the first magnet 1.

When moving the first magnet 1 across a gap 24, 25, 26, 27, no field peaks are arranged in the region of the respective gap 24, 25, 26, 27.

The operating mode of the magnetic linear drive is based on the same principle as the magnetic rotary drive.

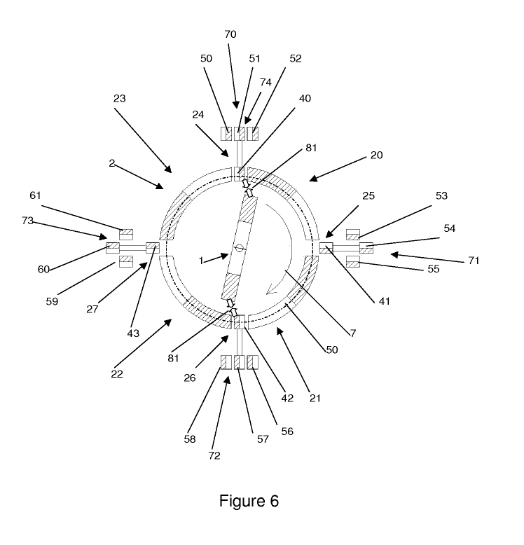

FIG. 6 shows an embodiment of a magnetic rotary drive similar to the embodiments shown in FIGS. 1 and 2. Here, fourth magnetic arrangements 70, 71, 72, 73 are provided. The fourth magnetic arrangement 70 consists of the fourth individual magnets 50, 51, 52, the fourth magnetic arrangement 71 consists of the fourth individual magnets 53, 54, 55, the fourth magnetic arrangement 72 consists of the fourth individual magnets 56, 57, 58, and the fourth magnetic arrangement 73 consists of the fourth individual magnets 59, 60, 61. The fourth individual magnets 51, 54, 57, 60 of the fourth magnets 70, 71, 72, 73 are connected with the respective third permanent magnets 40, 41, 42, 43. The fourth individual magnets 50, 52 or 53, 55 or 56, 68 or 59, 61 of the fourth magnetic arrangements 70, 71, 72, 73 are oriented towards the fourth individual magnets 51, 54, 57, 60 with different poles.

The operating mode of the fourth magnetic arrangement 70, 71, 72, 73 is explained in detail with reference to the example of the fourth magnetic arrangement 70. According to the invention, the third permanent magnet 40 is introduced into the gap 24 for generating a field strength peak 30. In this case, repulsive forces between equal poles are active between the third permanent magnet 40 and the magnets 20, 23 adjacent to the third permanent magnet 40.

If the third permanent magnet 40 is positioned outside the gap 24, the fourth individual magnet 51 is also positioned outside the gap 74, which is formed by the fourth individual magnets 50, 52. The sum of the attractive forces of different poles that are active between the fourth individual magnets 50, 51, 52 is essentially the same as the sum of the repulsive forces of equal poles that are active between the third permanent magnet 40 and the second individual magnet 20, 23. The third permanent magnet 40 can thus be easily inserted into the gap 24.

In the embodiment shown in FIG. 6, the gap 24 is closed by the third permanent magnet 40 and the gap 26 is closed by the third permanent magnet 42 at the time t so that the first magnet 1 is moved relative to the second magnet 2 essentially by the repulsive forces 81. The individual magnet 20 and the individual magnet 21 or the individual magnet 22 and the individual magnet 23, respectively, act as one magnet.

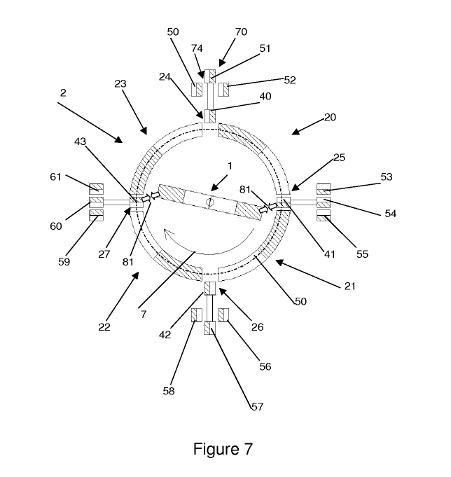

FIG. 7 shows the magnetic rotary drive shown in FIG. 6 at the time t+1. At the time t+1, the gaps 25, 27 are closed by the third permanent magnets 41, 43, while the gaps 24, 26 are open.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A magnetic drive comprising a first magnet (1) and a second magnet (2), wherein the first magnet (1) is positioned in a way that the first magnet (1) is constantly within the sphere of influence of the second magnet (2), wherein
the second magnet (2) comprises several individual magnets (20, 21, 22, 23), which are each spaced apart from each other by one gap (24, 25, 26, 27),
wherein local field strength peaks (30) controllable with regard to the position of the first magnet (1) relative to the second magnet (2) can be generated in the second magnet (2) by means of a magnetization means so that the first magnet (1) is movable relative to the second magnet (2) by means of the attractive force (80) between different poles of the first magnet (1) and of the second magnet (2) controlled by the controllable local field strength peaks (30), or by means of the repulsive force (81) of equal poles of the first magnet (1) and the second magnet (29) controlled by the controllable local field strength peaks (30).

2. The magnetic drive according to claim 1, wherein a third permanent magnet (40, 41, 42, 43) is provided as a magnetization means in the region of the gap (24, 25, 26, 27) and is displaceable between a position within the gap (24, 25, 26, 27) and a position outside the gap (24, 25, 26, 27), wherein the third permanent magnet (40, 41, 42, 43) is, in the position within the gap (24, 25, 26, 27), oriented towards the adjacent second individual magnets (20, 21, 22, 23) with the same pole, and field strength peaks (30) may be generated in the region of the gap (24, 25, 26, 27) by positioning the third permanent magnet (40, 41, 42, 43) within or in the region of the respective gap (24, 25, 26, 27).

3. The magnetic drive according to claim 1, wherein a device (50, 51, 52, 53) for generating an electromagnetic field is arranged as magnetization means in the region of the gap (24, 25, 26, 27), wherein the device (50, 51, 52, 53) is oriented towards the adjacent second individual magnets (20, 21, 22, 23) with the same poles and a field strength peak (30) can be generated in the region of the gap (24, 25, 26, 27).

4. The magnetic drive according to claim 1, wherein the first magnet (1) is arranged at a predefined distance from the second magnet (2).

5. The magnetic drive according to claim 1, wherein the second magnet (2) is arranged around the first magnet (1), the polar axis (28) of the second magnet (2) is parallel with the arrangement of the second magnet (2), and the first magnet (1) is mounted rotatably around the center of the arrangement of the second magnet (2), so that a rotating movement of the first magnet (1) relative to the second magnet (2) can be generated.

6. The magnetic drive according to claim 1, wherein the second magnet (2) extends along a polygonal line, the polar axis (28) of the second magnet (2) is oriented parallel with the polygonal line, and the first magnet (1) is movable parallel with the polar axes (101, 102, 103, 104).

7. The magnetic drive according to claim 2, wherein the first magnet (1) and/or the second magnet (2) and/or optionally the third permanent magnet (40, 41, 42, 43) are powered by an external energy source.

8. The magnetic drive according to claim 1, wherein the velocity of the movement of the first magnet (1) and/or the capacity of the magnetic drive are controllable via the strength of the field strength peaks (30).

9. The magnetic drive according to claim 1, wherein the field strength peaks (30) are, seen in the movement direction (7) of the first magnet (1), arranged before the first magnet (1) when the first magnet (1) is moved by the attractive forces (80) between the first magnet (1) and the second magnet (2), or arranged after the first magnet (1) when the first magnet (1) is moved by the repulsive forces (81) between the first magnet (1) and the second magnet (2).

10. The magnetic drive according to claim 1, wherein the field strength peak (30) for driving the first magnet (1) in the region of the, seen in the movement direction, first polar field (34, 35), towards which the first magnet (1) is oriented with the same poles, is arranged in the region of the, seen in the movement direction, first gap (24).

11. The magnetic drive according to claim 1, wherein the field strength peak (30) for driving the first magnet (1) in the region of the second polar field (34, 35) are arranged in the region of the gap (24, 25, 26, 27).

12. The magnetic drive according to claim 1, wherein there is preferably no field peak (30) in the region of the respective gap when the first magnet (1) is moved in the region of the gap (24, 25, 26, 27).

13. The magnetic drive according to claim 1, wherein the magnetic drive comprises several first magnets (1, 1′), wherein the first magnet (1) and a further first magnet (1′) are coupled with each other, and the first magnet is positioned in the region of a second individual magnet (20, 21, 22, 23), preferably in the region of the first polar field (24), while the further first magnet is positioned in the region of a gap (24, 25, 26, 27).
